(19) United States
(12) Patent Application Publication
(10) Pub. No.: US 2003/0230700 A1
(43) Pub. Date: Dec. 18, 2003

(54) Adjustable support member for manufacturing tool and other equipment

(76) Inventor: Zoltan A. Kemeny, Tempe, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/461,226

(22) Filed: Jun. 13, 2003

Related U.S. Application Data
(60) Provisional application No. 60/388,681, filed on Jun. 13, 2002.

(51) Int. Cl. F16M 1/00

(52) U.S. Cl. 248/677

(57) ABSTRACT

An adjustable support stand (30) supports equipment above a foundation. A body (56) has a threaded sleeve (58). A shaft (60) has a support end for supporting the equipment and a threaded end for screwing into the threaded sleeve of the body to adjust a height of the support stand. An isolation bearing assembly (70) is disposed on the support end of the shaft for providing isolation to the equipment. Four legs (46) are connected to the body. Each leg has a vertical channel member (80) in contact with the foundation and a diagonal brace member (90) coupling the vertical channel member to the body. The legs are individually extendable in length. A leg extension assembly (116) can be used to extend the height of the support stand.

### CLAIM TO DOMESTIC PRIORITY

The present non-provisional patent application claims priority to provisional application serial No. 60/388,681, entitled “Quad-Pod,” and filed on Jun. 13, 2002, by Zoltan A. Kemeny.

### FIELD OF THE INVENTION

The present invention relates, in general, to equipment support members and, more particularly, to an adjustable support member for manufacturing tools and other equipment.

### BACKGROUND OF THE INVENTION

Semiconductor devices are commonly used in the construction of electronic circuits for many types of electronic and consumer products. Integrated circuits and semiconductor devices are manufactured in specially constructed factories using highly customized and proprietary equipment and processes. The small nature of the individual semiconductor components comprising most integrated circuits, the demand for high reliability, and their susceptibility to contamination mandate the use of clean rooms and special manufacturing tools.

The tools and equipment used in the manufacture of semiconductors can generally be placed in one of two categories: tools that generate vibration and tools that receive vibrations. Examples of vibration-generating tools include chemical mechanical polishers (CMP) and other rotating or oscillating machinery. Examples of tools that are susceptible to vibration include optical devices such as burning tools and etchers, scanning electronic microscopes, and inspection tools.

Semiconductor clean rooms are typically configured with a raised floor constructed with a number of rectangular panels or plates suspended over a concrete base, slab on grade, or other solid foundation. The raised floor provides access to electrical conduits, wiring, piping, ventilation, duct works, and drainage running along and around the foundation. The semiconductor manufacturing tools and other equipment found in clean rooms must be mounted to a table, base plate, stand, or other assembly to support the mass of the tool in a stable and secure manner above the access floor, and to minimize the transfer of any vibrations between sets of equipment. If any vibration originating from rotating machinery should be transferred to vibration-sensitive equipment, then the manufacturing process being performed by such vibration-sensitive equipment could be impaired. For example, many optical burners or etchers are high precision tools operating in the nanometer range. Any vibration in the equipment can cause jitter or blur the optical focus and create defects in the integrated circuits.

Manufacturing tools are often mounted to tables or plates which are in turn supported by rigid pedestals or “elephant legs”, which are short-stands located under each corner or support area of the tool table. The raised flooring is arranged around the equipment support members. An example of a prior art pedestal is shown in FIG. 1. A manufacturing tool 10, such as a CMP found in semiconductor clean rooms, is supported by leveler legs 12 each having foot 14. An adjustable nut 16 turns to lengthen and shorten leg 12 to balance and provide support for manufacturing tool 10.

Another known tool support uses a rigid welded frame assembly to support heavy equipment, e.g. in the range of hundreds to thousands of lbs. The tool support uses a framework of interconnected steels channels which are welded or bolted to the foundation. Each frame assembly is usually custom built to fit in and around existing structures on the foundation, e.g. pipes, conduits, and drains. The frame assembly is heavy, time consuming and expensive to set-up and maintain, and tends to add contaminants to the clean room environment. The rigid construction of the frame assembly makes it difficult and inflexible to move or re-configure with changes in equipment and clean room layout. If it becomes necessary to move the equipment, substantial planning and re-work to the frame assembly is often needed to meet the foundation slope and drainage requirements and to avoid existing structures and obstacles in the new area. Many times the frame assembly must be completely re-built. Even with careful measurements and planning, unforeseen complications can arise with the many tradespersons co-existing and interfacing in clean room floor access space.

### SUMMARY OF THE INVENTION

In one embodiment, the present invention is a support member for supporting equipment above a foundation comprising a body having a threaded sleeve, a shaft having a support end for supporting the equipment and a threaded end for screwing into the threaded sleeve of the body to adjust a height of the support member, and first, second, and third legs coupled to the body, wherein each leg includes a vertical channel member in contact with the foundation and a diagonal brace member coupling the vertical channel member to the body.

In another embodiment, the present invention is an adjustable height equipment support stand, comprising a body including an extendable shaft threaded into the body, and first, second, and third legs coupled to the body, wherein each leg includes a vertical channel member and a diagonal brace member coupling the vertical channel member to the body.

In yet another embodiment, the present invention is a method of supporting equipment above a foundation comprising providing a shaft for supporting the equipment, rotating a threaded end of the shaft through a body to raise and lower the equipment, and supporting the body with first, second, and third legs, wherein each leg includes a vertical channel in contact with the foundation and a diagonal brace coupling the vertical channel to the body.

### BRIEF DESCRIPTION OF THE DRAWINGS

FIG. 1 illustrates a prior art support member for a manufacturing tool;

FIG. 2 illustrates a semiconductor clean room with access floor and tool pedestal assembly;

FIGS. 3a-3c illustrate quad-pod assemblies supporting a semiconductor manufacturing tool;

FIGS. 4a and 4b illustrate features of the quad-pod assembly;

FIGS. 5a and 5b illustrate a quad-pod assembly with shorter legs;

FIGS. 6a and 6b illustrate a quad-pod assembly with vibration isolation bearing assembly and tie-down rod;

FIGS. 7a and 7b illustrate a quad-pod assembly with leg extensions;

FIGS. 8a and 8b illustrate the quad-pod head subassembly;

FIGS. 9a and 9b illustrate the leg subassembly with vertical pipe member and diagonal brace member;

FIGS. 10a-10c illustrate the diagonal brace member with various kick angle configurations;

FIGS. 11a and 11b illustrate a locking net for locking pipe-screw in place;

FIG. 12 illustrates an adaptor puck for reducing rim diameter of the quad-pod head subassembly;

FIG. 13 illustrates a swivel head assembly for the quad-pod head subassembly;

FIG. 14 illustrates a cable tie-down assembly;

FIG. 15 illustrates a shackle and chain tie-down assembly; and

FIGS. 16a and 16b illustrate a spanner wrench for hand turning the pipe-screw.

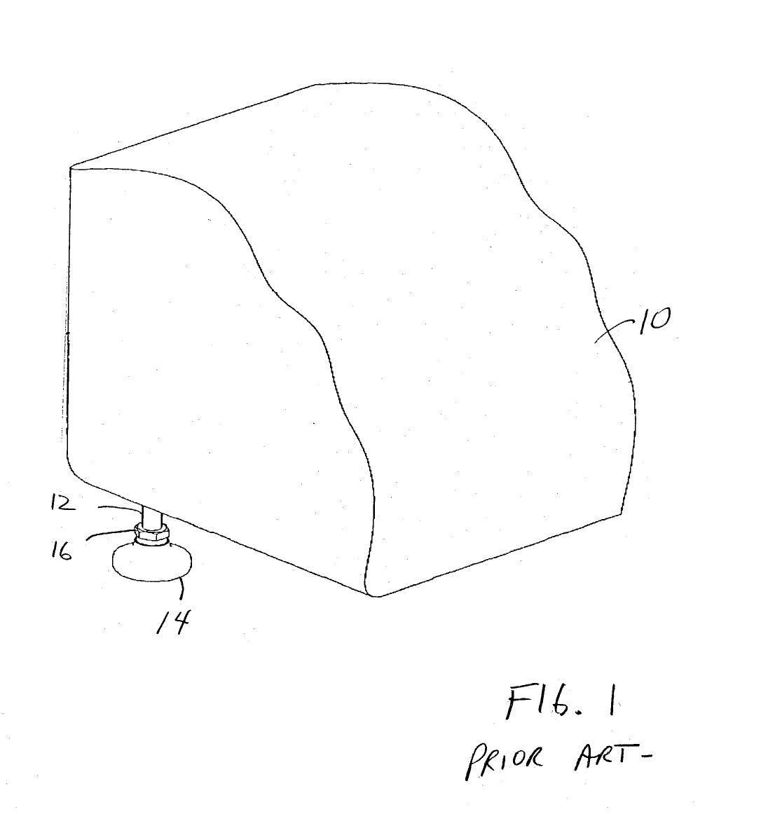

### DETAILED DESCRIPTION OF THE DRAWINGS

A semiconductor manufacturing clean room area is shown in FIG. 2. An access floor 20 comprises a plurality of rectangular panels or plates 22 supported by stands 24 resting on concrete base, slab on grade, or other solid foundation 25. The plates 22 may be 24-inches square and manufactured from aluminum. Access floor 20 surrounds tool pedestal assembly 26. Tool pedestal assembly 26 includes a base plate or table 28 upon which a semiconductor manufacturing tool or equipment is mounted. Base plate 28 is supported by four support assemblies 30, hereinafter referred to as quad-pods, in contact with foundation 25. Base plate 28 is raised over or flush with adjacent access floor plates 22. Diagonal strut 32, straight ties 34, and diagonal floor braces 36 provide stiffness for tool pedestal assembly 26 by holding quad-pods 30 together as a rigid braced structural support frame system.

Quad-pod 30 is a load-bearing tool stand or support member suitable for clean room installation in semiconductor facilities for mounting manufacturing tools and other equipment. Quad-pod 30 is constructed with clean room compatible materials and protective coatings. Semiconductor manufacturing tools include equipment which are known to generate vibrations such chemical mechanical polishers (CMP) and other rotating and oscillating machinery, and equipment which are susceptible to vibration such as optical burning tools and etchers, scanning electronic microscopes, and inspection tools.

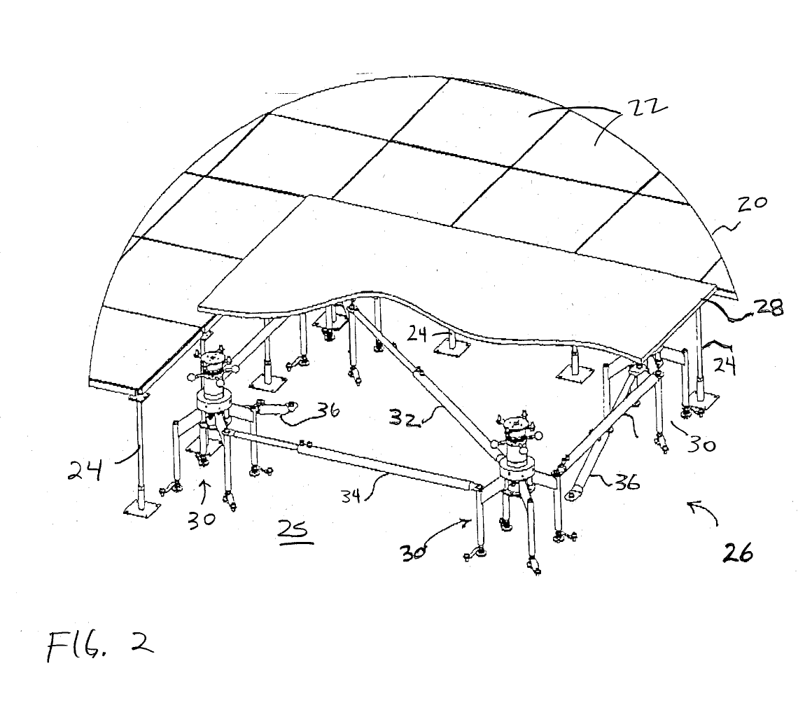

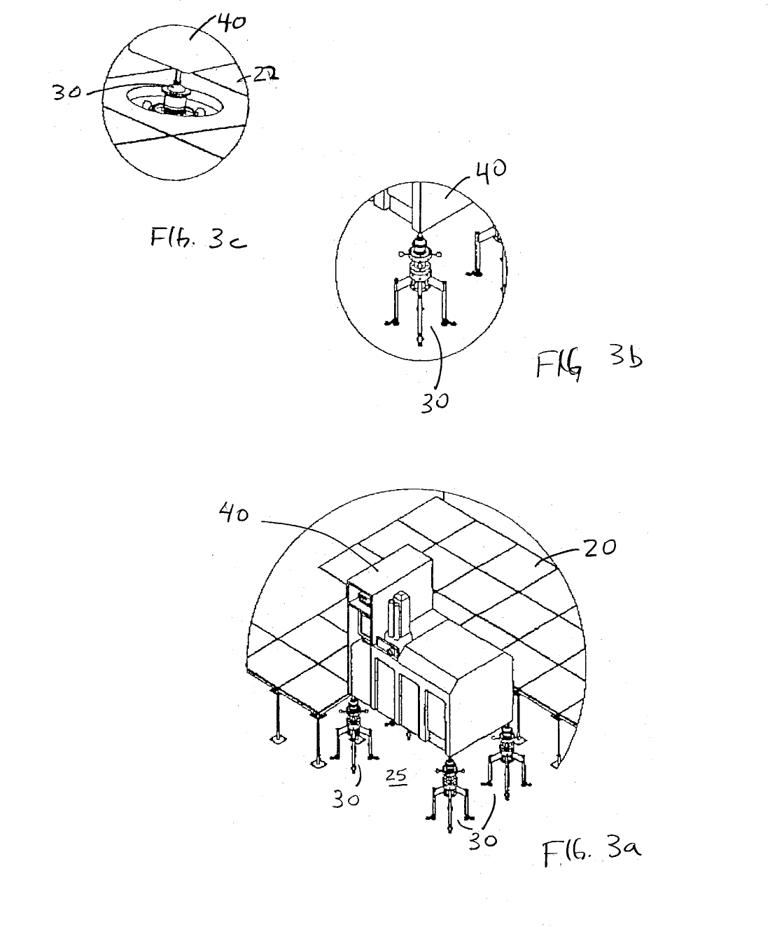

The manufacturing tool can be mounted onto rigid base plate 28 which is supported by one or more quad-pods 30. Alternatively, manufacturing tool 40 can be directly mounted to one or more quad-pods 30 such as shown in FIG. 3a. Quad-pods 30 are positioned under each corner or other loading surface of manufacturing tool 40 to maintain the tool at the desired height above foundation 25. FIG. 3b shows further detail of quad-pod 30 supporting one corner of manufacturing tool 40. The height of quad-pod 30 can be adjusted to that the bottom surface of manufacturing tool 40 is positioned below, level with, or above access floor 20. Access floor 20 can easily be placed on all sides of manufacturing tool 40 to provide convenient access to the equipment. FIG. 3c illustrates manufacturing tool 40 positioned above access floor 20 with quad-pod 30 extending through a cut-out in one of the access floor plates 22 to support one corner of the manufacturing tool.

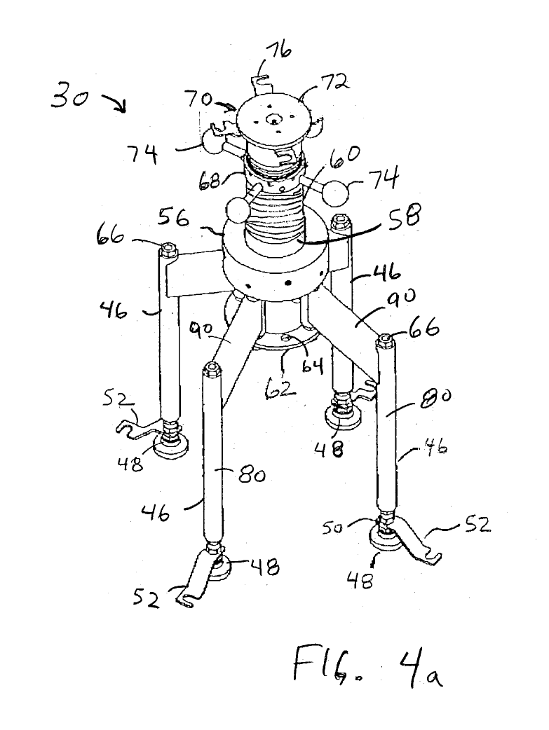

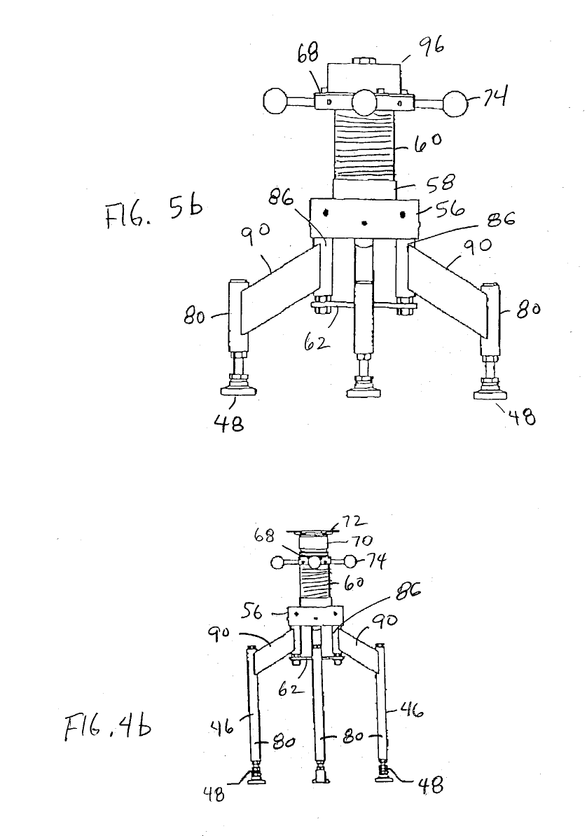

Further detail of quad-pod 30 is shown in FIG. 4a. Quad-pod 30 includes four legs 46, each having leveler screw and swivel foot assembly 48. In other embodiments, quad-pod 30 may have three legs 46 or five or more legs 46. The treaded stem of the leveler screw is screwed into nut 50 which is welded onto the bottom of each leg 46. Seismic clips or straps 52 are locked by nut 50 to anchor quad-pod 30 securely to foundation 25 in the event of an earthquake or should tool pedestal assembly 26 be jarred or bumped. The swivel foot accommodates for slope in the foundation for drainage. Leg 46 is a welded steel tube and pipe subassembly having a vertical pipe or channel member 80 and a diagonal brace member 90. The diagonal brace member of legs 46 is pin or socket-mounted to head or body 56. Head 56 has a threaded sleeve 58. Pipe-screw 60 is a male-threaded jack screw shaft for supporting, lifting, and leveling manufacturing tool 40 and/or base plate 28. Pipe-screw 60 threads into sleeve 58 which is a female receptacle. The threading is a square profile, low pitch, and Teflon-coated for ease of lifting under high load. Pipe-screw 60 makes quad-pod 30 adjustable in height to accommodate any distance or clearance between foundation 25 and manufacturing tool 40. Legs 46 are also individually adjustable with leveler screw and swivel foot assembly 48 to account for unevenness, variation in level, trenches, structures, and obstacles in and around foundation 25.

To reduce bending moment on the root of legs 46, a ring 62 is used to hold legs 46 together. Legs 46 are bolted, welded, or pinned to ring 62. Ring 62 includes additional holes 64 to receive braces, ties, and struts. The top of the vertical pipe member of leg 46 also has a welded nut 66 to receive braces, ties, and struts. Pipe-screw 60 is topped by a welded circular head 68, which supports a vibration isolation bearing assembly 70. Isolation bearing assembly 70 provides isolation for vibrations being received from foundation 25 for vibration-sensitive manufacturing tools and other equipment. Isolation bearing assembly 70 also has a swivel head 72 to accommodate pedestal or tool leveling on the fly, i.e. while performing a lifting operation. The lifting is facilitated by lever arms 74 which provide for screwing pipe-screw 60 by hand. Lever arms 74 can unscrew from head 68 when not in use or when horizontal space is limited. Head 68 also has tool socket holes to receive spanner wrench or other special tools for turning pipe-screw 60 by hand. Seismic clips 76, which are similar to clip 52, are attached head 72 for anchoring base plate 28 or manufacturing tool 40. A side view of quad-pod 30 is shown in FIG. 4b.

A quad-pod 30 is placed under each corner, or other location requiring load support, of base plate 28 and/or manufacturing tool 40. Legs 46 are in contact with foundation 25 for a solid base. The portion of legs 46 in proximity to foundation 25, i.e. vertical pipe member 80 and leveler screw and swivel foot assembly 48, are mechanically isolated from one another. There is no separate bracing between legs 46 on or around vertical pipe member 80 or assembly 48 in the vicinity of foundation 25. Therefore, with separate and individual vertical channel members 80, quad-pod 30 can be rotated and oriented so that legs 46 straddle or otherwise avoid any structures and obstacles on and around the foundation. In other words, legs 46 can be positioned over, under, around, or along side existing structures and obstacles such as piping, conduits, ductwork, and drainage. Leveler screw and swivel foot assembly 48 can be adjusted to account for any deformation or slope in the foundation while maintaining the centerline of quad-pod 30 within vertical tolerance. Lever arms 74 turn pipe-screw 60 to raise or lower the overall height of quad-pod 30 and bring isolation bearing assembly 70 and swivel head 72 in contact with and to support base plate 28 and/or manufacturing tool 40. Quad-pod 30 can adjusted in height by turning pipe-screw 60 to support manufacturing tool 40 at any desired height above foundation 25. The threaded features of assembly 48 and pipe-screw 60 allow quad-pod 30 to lift, lower, level, and align practically any manufacturing tool. In one embodiment, a quad-pod 30 weighting about 120 lbs can support a load up to 8000 lbs. Quad-pod 30 provides six degrees of freedom: displacements in x-direction, y-direction, and z-direction, and corresponding rotations for each displacement.

Quad-pod 30 is designed and built to accommodate variations in access floor height and slope, leg locations, slant in concrete floor for drainage, trench lines, and to straddle and avoid utility pipes, boxes, conduits, and other fixed structures. Quad-pod 30 can be factory or field assembled and includes telescoping ties, braces, struts, cables, and anchorages. Quad-pod 30 is rigid, strong, light weight, and can be quickly assembled in the field from easily transportable components. The attachment, fixture, and anchor bolts and other hardware are one size fits all and interchangeable.

FIG. 5a illustrates another version of quad-pod 30 with shorter vertical pipe members for legs 46 to accommodate shallow access floors 20. Figure elements having the same or similar function are given the same reference numbers. In this embodiment, the top of the vertical pipe member 80 of leg 46 is capped with plastic plug 82 when not receiving any structural attachments due to the shortness of legs 46. Diagonal brace members 90 are pinned through slots 86 between head 56 and ring 62 for free rotation of legs 46 to avoid obstacles such as conduits, boxes, tubing, plumbing, and other mechanical structures on or around foundation 25. Head 56 uses setscrews 84 to lock sleeve 58 in place and setscrews 88 to lock diagonal brace members 90 in place. Setscrew 94 locks head 68 in place. Head 68 receives a shallow, high-load, short-stroke vibration isolation bearing assembly 96, having a spherical top (button head) part, which receives the pedestal plate. Isolation bearing assembly 96 is designed to reduce vibrations transferred to foundation 25 from vibration-generating tools and equipment being supported by quad-pod 30. A side view of the shorter version of quad-pod 30 is shown in FIG. 5b.

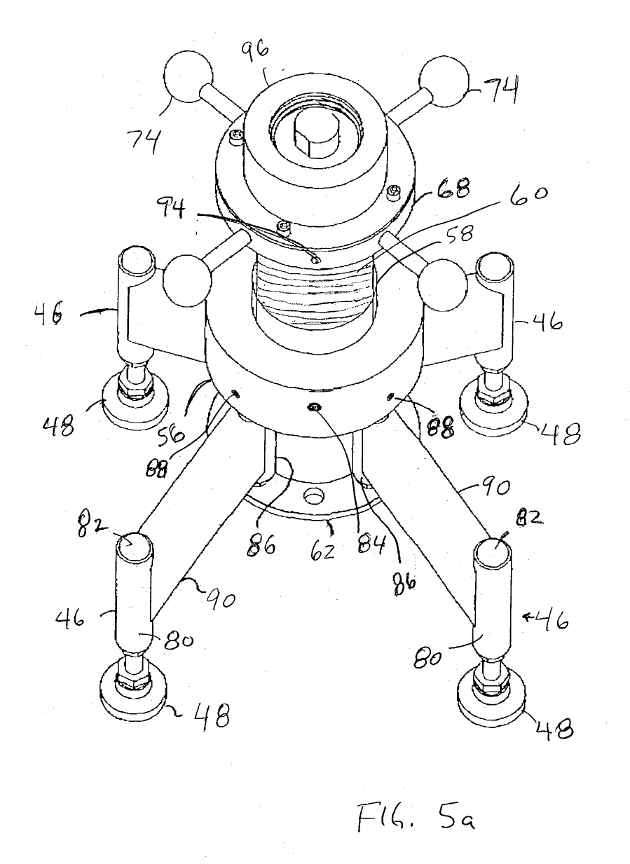

FIG. 6a illustrates a short quad-pod 30 assembly with isolation bearing assembly 98 having a swivel head 100 to support base plate 28 and/or manufacturing tool 40. Isolation bearing assembly 98 provides a strong, long stroke vibration isolation feature for quad-pod 30. The top portion of head 100 swivels independent of isolation bearing assembly 98 to provide rotational freedom and easy of installation and operation in lifting and leveling manufacturing tool 40. FIG. 6a also illustrates tie assembly 106 including threaded rod 108. Rod 108 screws into vertical pipe member 80. Nut 110 secures tie assembly 106 to base plate 28 to provide a seismic continuity feature to hold base plate 28 down to quad-pod 30, which in turn is anchored to foundation 25 by clips 52 as shown in FIG. 4a. FIG. 6b shows a side view of the short quad-pod 30 assembly with isolation bearing assembly 98 and swivel head 100.

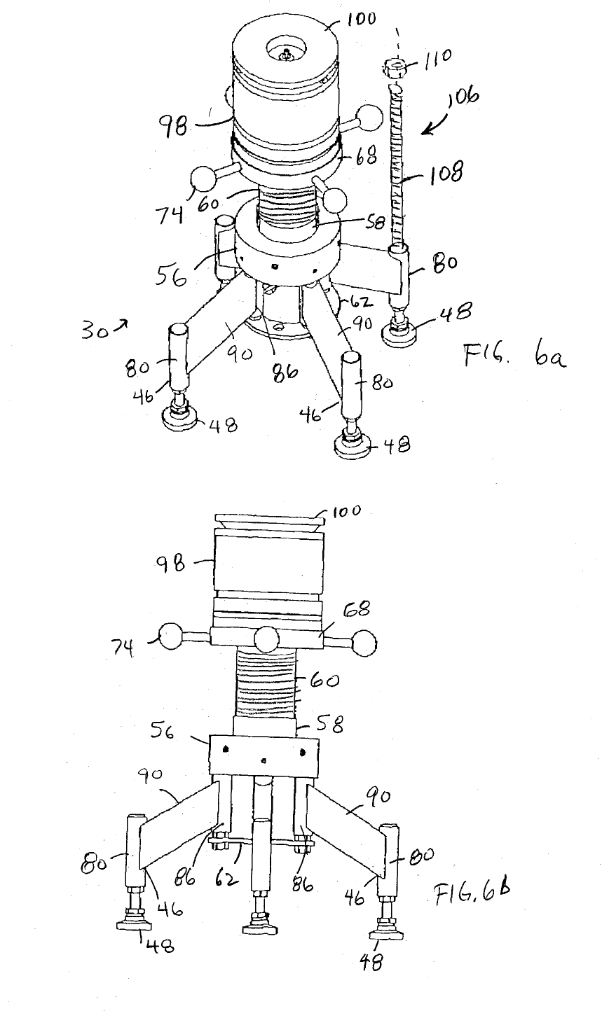

FIG. 7a illustrates a quad-pod 30 assembly with vibration isolation bearing assembly 98 and swivel head 100. A leg extension assembly 116 provides a mechanism to extend the vertical length and increase load bearing capacity of quad-pod 30 while reducing stress on legs 46. Quad-pod 30 assembly with leg extension assembly 116 can support a heavy load at greater height above foundation 25 without buckling. Leg extension assembly 116 includes vertical pipes or channel members 118 inserted into sleeve 120 of brace or strut-tie assemblies 122. Vertical pipes 80 also slide into sleeves 120 and both are secured by setscrews 124. Leg extension assembly 116 is a modulator design which allows multiple leg extension assemblies to be added to further increase the height of quad-pod 30. With one or more leg extension assemblies 116, quad-pod 30 can range in height from 0.5 to 7.5 feet or more. FIG. 7b shows a side view of the quad-pod 30 assembly with leg extension assembly 116.

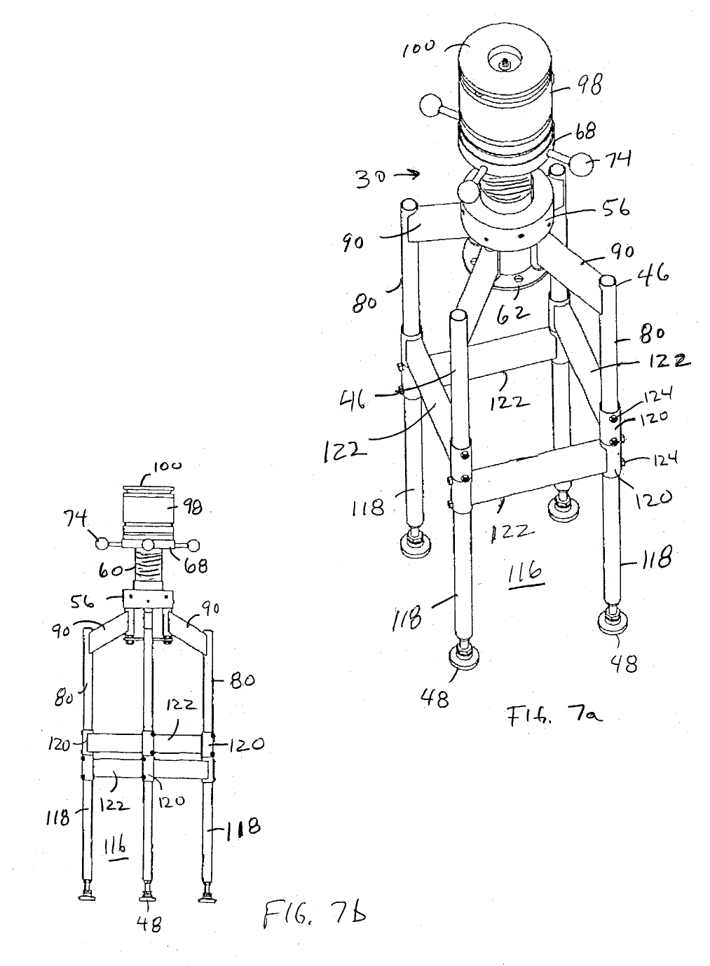

FIG. 8 illustrates the quad-pod head subassembly with pipe-screw 60 and head 68. Lever arms 74 are bolted or screwed into head 68 to turn pipe-screw 60. Head 68 has holes 130 for receiving a spanner wrench to hand turn pipe-screw 60. Head 68 also has setscrew holes 132 to lock mating isolation bearing assembly 70 or 98, swivel head 72, base plate 28, or manufacturing tool 40. Tapped holes 134 are provide for anchoring seismic clips or tool leg hold-downs. FIG. 8b shows a side view of the quad-pod head subassembly.

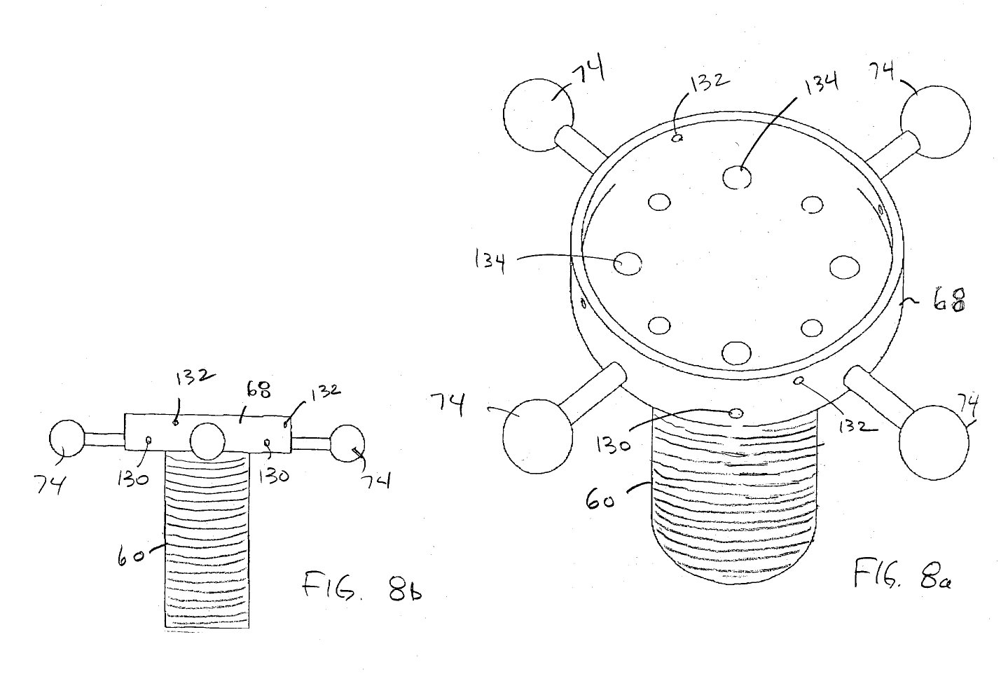

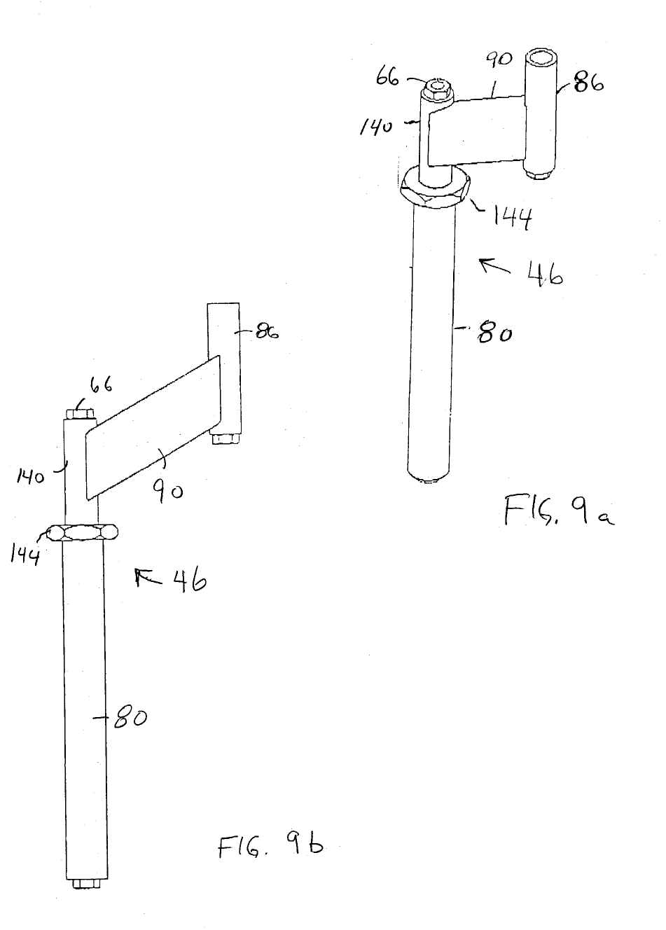

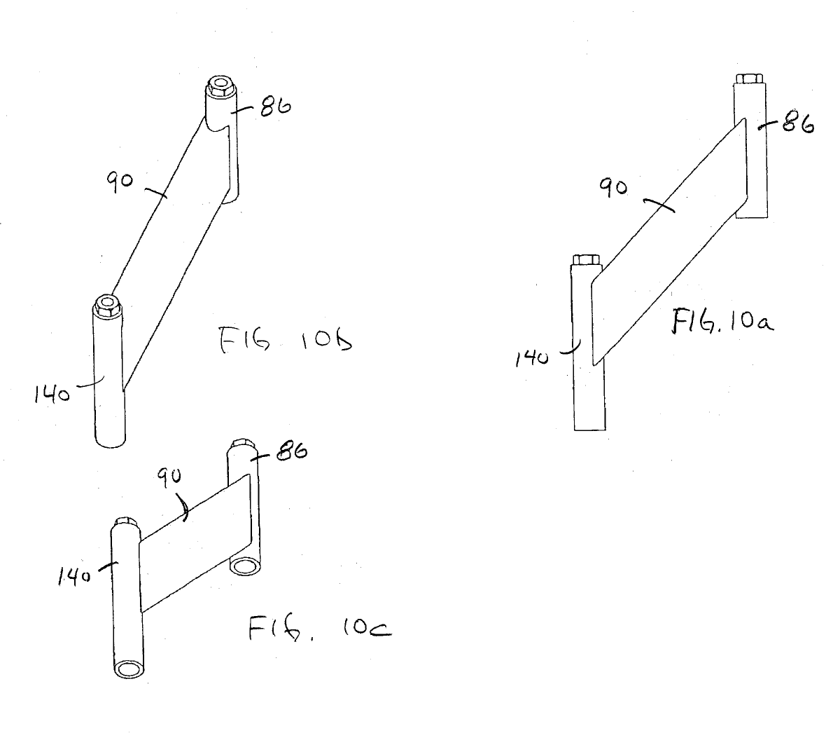

FIG. 9a illustrates leg 46 with telescoping vertical pipe extension 140. Diagonal brace member 90 is welded to pipe extension 140. Extension 140 has a length which is inserted into vertical pipe member 80. Extension 140 can then be adjusted to increase the overall length of leg 46. Locking nut 144 holds the desired length of extension 140 in place. Leg extensions 140 provide for individual adjustment to the length of legs 46 to account for unevenness and structures in and around foundation 25. FIG. 9b shows a side view of leg 46 with telescoping vertical pipe extension 140. FIGS. 10a-10c illustrate diagonal brace members 90 with various kick angle configurations.

FIG. 11a illustrates a lock nut 150 for locking pipe-screw 60 in place. Lock nut 150 includes spanner holes 152 for locking tool access and finger rim 154 for easy operation by hand. Lock nut 150 holds pipe-screw 60 securely in place and prevents any loosening, movement, or rattling. FIG. 11b shows a top view of lock nut 150.

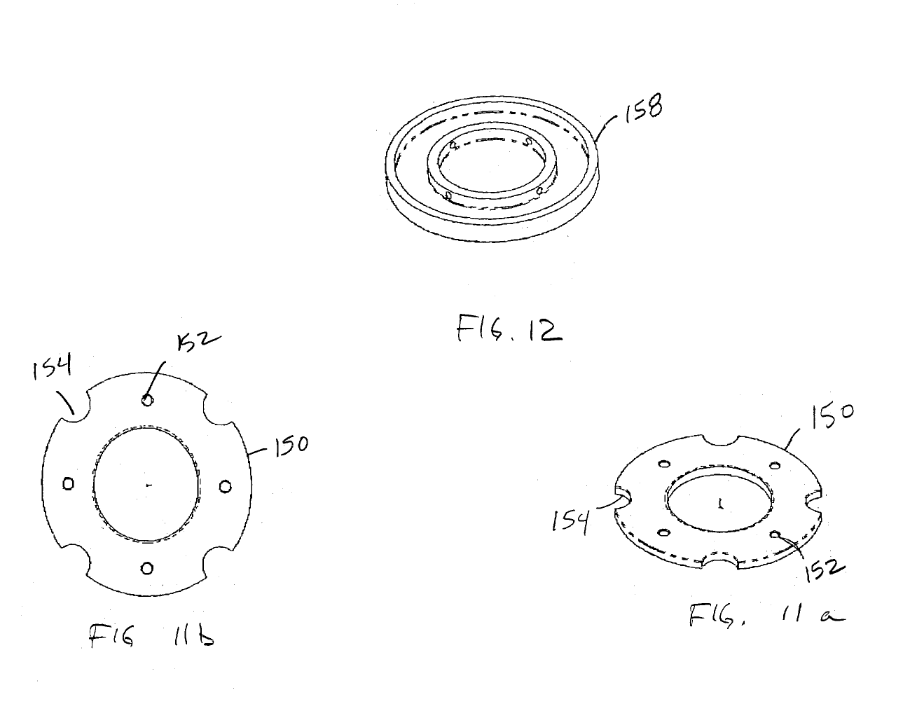

FIG. 12 shows an adapter puck 158 for reducing the rim diameter of head 68. In some lower load bearing applications of quad-pod 30, it is desirable to use smaller diameter isolation bearing assemblies and swivel bearings. Adaptor puck 158 is mounted to the standard size head 68 such as shown in FIG. 8a. Each adaptor puck 158 can be sized to receive a different isolation bearing assembly and swivel bearing.

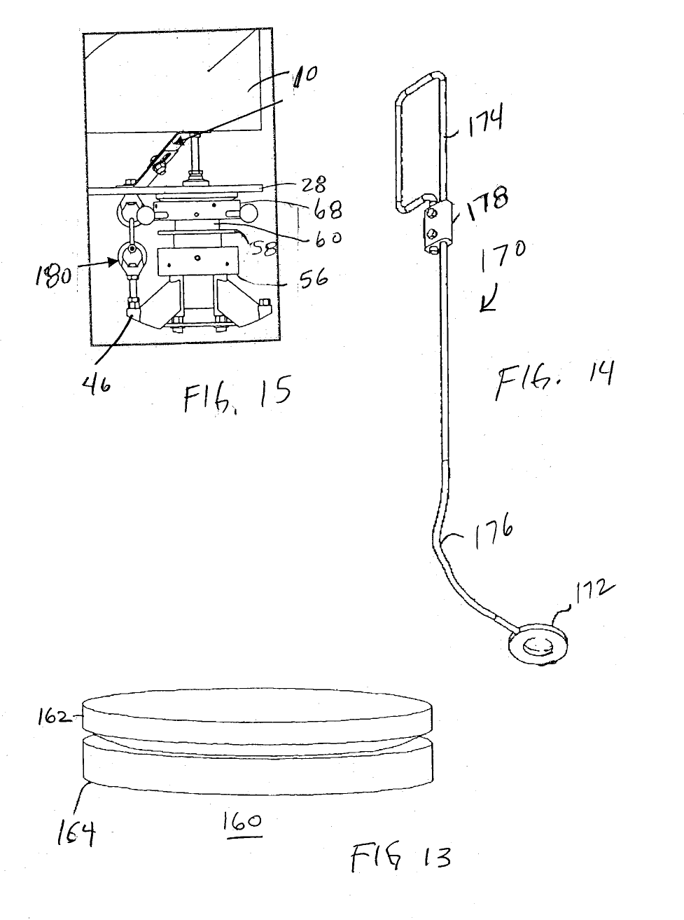

FIG. 13 illustrates a swivel head assembly 160, which is mounted between head 68 and base plate 28 and/or manufacturing tool 40 to accommodate for any uneven placement or leveling of the load surface. Swivel head assembly 160 has a spherical plug 162 sitting in a matching socket 164 with a Teflon coating for smooth swiveling. Plug 162 rotates freely in angle and orientation with respect to socket 164 to allow quad-pod 30 remain vertical while providing solid and uniform support of the load surface. Swivel head assembly 160 is also useful when foundation 25 is unlevel or uneven. The centerline of quad-pod 30 may be off-vertical while base plate 28 remains horizontal.

FIG. 14 shows a cable tie-down assembly 170 between leg 46 and manufacturing tool 40. Cable tie-down assembly 170 has an eye ring 172 at one end and loop 174 at the other end with interconnecting cable 176 and cable clip 178. Eye ring 172 holds manufacturing tool 40 while loop 174 warps around leg 46 to anchor the manufacturing tool or supported equipment in the event of an earthquake or should tool pedestal assembly 26 be jarred or bumped. Base plate 28 has pass-through hole for cable 176.

FIG. 15 shows an alternate embodiment of the manufacturing tool tie-down assembly with interlocking shackle and chain assembly 180 connecting between leg 46 and manufacturing tool 40. Shackle and chain assembly 180 provides an anchor for seismic continuity from manufacturing tool 40 passing through base plate 28 to quad-pod 30 and finally to foundation 25 by way of clips 52.

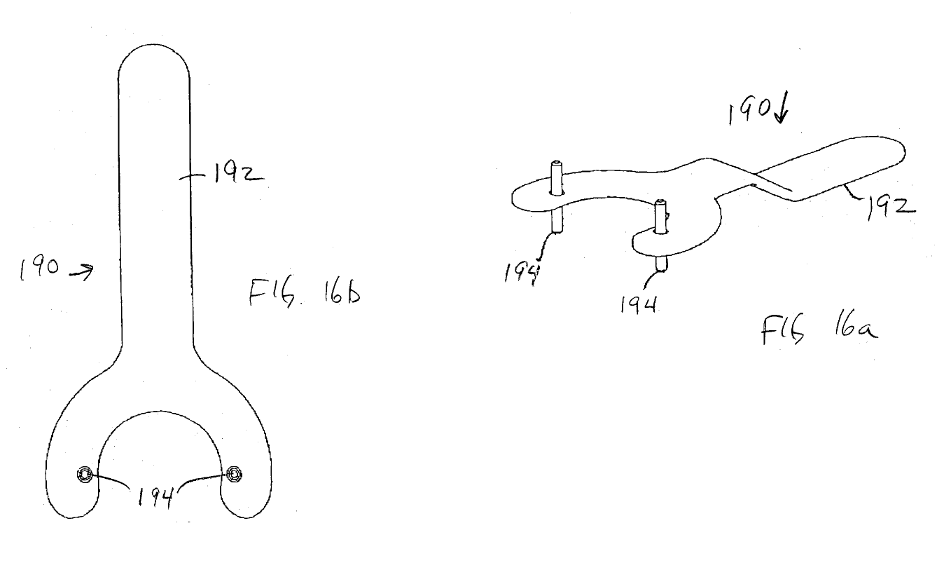

FIG. 16 illustrates a spanner wrench 190 with handle 192 and welded jigs 194. Spanner wrench mates in holes 130 to hand rotate pipe-screw 60 and adjust the height of the quad-pod head subassembly. In an alternate embodiment, an electric motor can be used to turn pipe-screw 60 and adjust the height of the quad-pod head subassembly.

As illustrated in the preceding figures, quad-pod 30 is modularly constructed with interchangeable components. This feature allow quad-pod 30 to be easily adapted to the loading requirements, spacing, structures, obstacles, and surface orientation of foundation 25. Quad-pod 30 can be placed in and around many existing structures and obstacles while accounting for variation in evenness and level of the foundation surface. Quad-pod 30 can then be adjusted to a wide range of heights to match the clearance requirement for manufacturing tool 40 above foundation 25. Quad-pod 30 supports manufacturing tool-40 is a variety of environments and conditions. Quad-pod 30 is easily taken down and moveable to setup and support other equipment.

Quad-pod 30 has many other applications. Quad-pod 30 could be used in construction, remodeling, and any other area where there is a need to support an object. Quad-pod 30 provides a convenient and cost effective alternative to fixed frame assemblies and can be adapted to fit in and around the existing environment.

The present invention has been described with respect to preferred embodiment(s). Any person skilled in the art will recognize that changes can be made in form and detail, and equivalents may be substituted for elements of the invention without departing from the spirit and scope of the invention. Many modifications may be made to adapt to a particular situation or material to the teaching of the invention without departing from the essential scope of the invention. Therefore, it is intended that the invention not be limited to the particular embodiments disclosed for carrying out this invention, but that the invention will include all embodiments falling within the scope of the following claims.

What is claimed is:

1. A support member for supporting equipment above a foundation, comprising:
a body having a threaded sleeve;
a shaft having a support end for supporting the equipment and a threaded end for screwing into the threaded sleeve of the body to adjust a height of the support member; and
first, second, and third legs coupled to the body, wherein each leg includes a vertical channel member in contact with the foundation and a diagonal brace member coupling the vertical channel member to the body.

2. The support member of claim 1 further including a fourth leg having a vertical channel member in contact with the foundation and a diagonal brace member coupling the vertical channel member to the body.

3. The support member of claim 1 wherein portions of the vertical channel member of the legs in proximity to the foundation are mechanically isolated to avoid structures.

4. The support member of claim 1 further including an isolation bearing assembly disposed on the support end of the shaft for providing isolation to the equipment.

5. The support member of claim 4 wherein the isolation bearing assembly includes a swivel head for supporting the equipment with free rotation.

6. The support member of claim 1 wherein the legs are extendable in length.

7. The support member of claim 1 further including a leg extension assembly coupled to the legs for extending a height of the support member.

8. The support member of claim 1 further including an adjustable swivel foot coupled to the vertical channel member in contact with the foundation.

9. The support member of claim 1 further including a clip to secure the legs to the foundation.

10. The support member of claim 1 further including a lever arm coupled to the shaft for rotating the threaded end of the shaft.

11. The support member of claim 1 wherein the diagonal braces members are pinned to the body for free rotation of the legs.

12. A quad-pod support stand, comprising:
a shaft having a support end and a threaded end;
a body coupled for receiving the threaded end of the shaft; and
at least four legs coupled to the body, wherein each leg includes a vertical channel member and a diagonal brace member coupling the vertical channel member to the body.

13. The quad-pod support stand of claim 12 wherein the body includes a threaded sleeve coupled for receiving the threaded end of the shaft.

14. The quad-pod support stand of claim 12 further including an isolation bearing assembly disposed on the support end of the shaft.

15. The quad-pod support stand of claim 12 wherein the legs are extendable in length.

16. The quad-pod support stand of claim 12 further including a leg extension assembly coupled to the legs for extending a height of the quad-pod support stand.

17. The quad-pod support stand of claim 12 wherein the diagonal braces members are pinned to the body for free rotation of the legs.

18. An adjustable height equipment support stand, comprising:
a body including an extendable shaft threaded into the body; and
first, second, and third legs coupled to the body, wherein each leg includes a vertical channel member and a diagonal brace member coupling the vertical channel member to the body.

19. The adjustable height equipment support stand of claim 18 further including a fourth leg having a vertical channel member and a diagonal brace member coupling the vertical channel member to the body.

20. The adjustable height equipment support stand of claim 18 further including an isolation bearing assembly disposed on one end of the extendable shaft.

21. The adjustable height equipment support stand of claim 20 wherein the isolation bearing assembly includes a swivel head with free rotation.

22. The adjustable height equipment support stand of claim 18 wherein the legs are extendable in length.

23. The adjustable height equipment support stand of claim 18 further including a leg extension assembly coupled to the legs for extending a height of the adjustable height equipment support stand.

24. A method of supporting equipment above a foundation, comprising:
providing a shaft for supporting the equipment;
rotating a threaded end of the shaft through a body to raise and lower the equipment; and
supporting the body with first, second, and third legs, wherein each leg includes a vertical channel in contact with the foundation and a diagonal brace coupling the vertical channel to the body.

25. The method of claim 24 further including the step of providing a fourth leg having a vertical channel member in contact with the foundation and a diagonal brace member coupling the vertical channel member to the body.

26. The method of claim 24 further including the step of providing an isolation bearing assembly disposed on the support end of the shaft.

27. The method of claim 24 further including the step of extending a length of the legs.

28. The method of claim 24 further including the step of providing a leg extension assembly coupled to the legs for extending to a height of the equipment.
